(19) United States
(12) Patent Application Publication
(10) Pub. No.: US 2014/0360448 A1
(43) Pub. Date: Dec. 11, 2014

(54) CAMSHAFT GUIDE MEMBER

(71) Applicant: Caterpillar Inc., Peoria, IL (US)

(72) Inventor: Jonathan R. Chittenden, Edwards, IL (US)

(21) Appl. No.: 13/913,570

(22) Filed: Jun. 10, 2013

(51) Int. Cl. F16H 53/02

(52) U.S. Cl. CPC F16H 53/025
USPC 123/90.6; 123/90.1; 29/888.1

(57) ABSTRACT

A camshaft guide member is provided for guiding a camshaft through a plurality of axially aligned camshaft bearings in an engine along a camshaft rotation axis. The camshaft guide member includes a first end, a second end and a contact surface extending between the first end and the second end. The camshaft guide member further includes a connecting portion configured to attach the contact surface to the engine between at least a pair of camshaft bearings.

### TECHNICAL FIELD

The present disclosure relates to an engine, and particularly to a camshaft guide member for removing and installing a camshaft in the engine.

### BACKGROUND

During rebuilding or servicing of an internal combustion engine or during an initial assembly of a new engine, the camshaft may be required to be installed or uninstalled from its position within the engine. This is generally done by guiding the camshaft into place along corresponding engine bore. Conventionally, the guiding of the camshaft for installation and/or removal processes is done by hand. When in place, the camshaft is supported on bearing surfaces of a soft bearing material within the engine. However, since the camshaft is a long and heavy part, it is generally difficult to handle. Therefore, while moving the camshaft, it may fall over the bearing surfaces, and thus cause damage to the bearing surfaces. Therefore, for minimizing the damage to the bearing surfaces of the engine, the guiding may be slow and complex by hand.

U.S. Pat. No. 4,450,609 relates to a camshaft having a plurality of journals with a removable sleeve positioned between at least one set of adjacent camshaft bearing journals. The sleeve has an outer surface which does not extend past the outer surface of the two adjacent journals and presents a continuous cylinder spanning the space between adjacent cam bearings thereby assisting in the insertion of the camshaft into an engine. After insertion into the engine, the sleeve is removed.

### SUMMARY

In one aspect, a camshaft guide member is provided for guiding a camshaft through a plurality of axially aligned camshaft bearings in an engine along a camshaft rotation axis. The camshaft guide member includes a first end, a second end and a contact surface extending between the first end and the second end. The camshaft guide member further includes a connecting portion configured to attach the contact surface to the engine between at least a pair of camshaft bearings.

In another aspect, an engine is provided. The engine includes a plurality of axially aligned camshaft bearings and a camshaft rotatably supported on at least two axially aligned camshaft bearings. The camshaft is configured to rotate about a camshaft rotation axis. The engine further includes a camshaft guide member configured to guide the camshaft through the camshaft bearings. The camshaft guide member includes a first end, a second end and a contact surface extending between the first end and the second end. The contact surface is disposed between the at least two camshaft bearings.

In a yet another aspect, a method for guiding a camshaft through axially aligned camshaft bearings in an engine is provided. The method includes providing at least one camshaft guide member between at least two camshaft bearings. Further, the method includes moving the camshaft while continuously supporting a camshaft journal on at least one of the camshaft guide member and the camshaft bearing.

### BRIEF DESCRIPTION OF THE DRAWINGS

FIG. 1 illustrates a perspective view of an engine;

FIG. 2 illustrates a fragmentary cross-sectional view of a part of an engine block of FIG. 1;

FIG. 3 illustrates perspective view of a camshaft guide member, in accordance with an embodiment of the present disclosure;

FIG. 4 illustrates perspective view of the camshaft guide member, in accordance with an alternate embodiment of the present disclosure;

FIG. 5 illustrates a bottom view of the engine having the camshaft guide member according to an embodiment of the present disclosure;

FIG. 6 illustrates a bottom view of the engine having the camshaft guide member according to an alternative embodiment of the present disclosure; and

FIGS. 7, 8 and 9 illustrate diagrammatic views of guiding the camshaft through the camshaft bearings according to an embodiment of the present disclosure.

### DETAILED DESCRIPTION

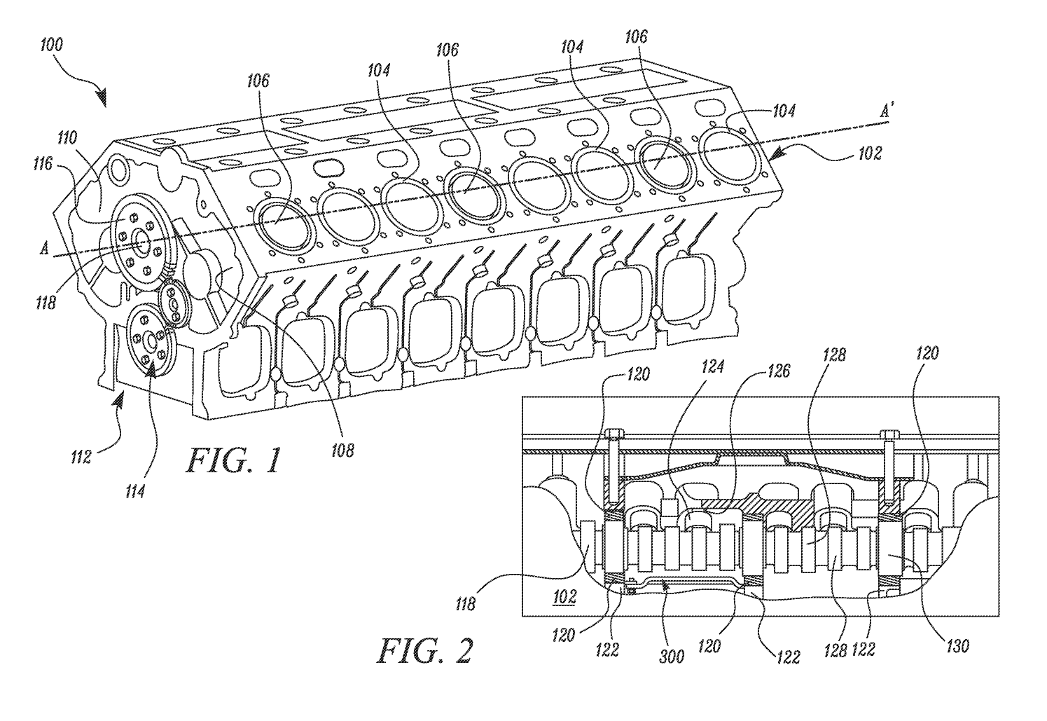

The present disclosure relates to a camshaft guide member for guiding a camshaft for installation and removal purposes within an engine. FIG. 1 illustrates an exemplary engine 100. The engine 100 may be any type of combustion engine, e.g., a spark-ignited internal combustion engine, a compression ignition internal combustion engine, for example a diesel engine, can be of any size, with any number of cylinders, and in any configuration (“V,” in-line, radial, etc.). The engine 100 may be used to power any machine or other device, including on-highway trucks or vehicles, off-highway trucks or machines, earth moving equipment, generators, aerospace applications, locomotive applications, marine applications, pumps, stationary equipment, or other engine powered applications.

In the illustrated embodiment, the engine 100 may be embodied as a V-type engine 100 including an engine block 102, and at least one engine head (not shown) mounted on the engine block 102. The engine block 102 is formed to provide obliquely disposed rows of cylinders 104 (only one row is shown in FIG. 1) in which pistons 106 are adapted to reciprocate. The rows of cylinder 104 are formed in the engine block 102 in cylinder banks 108, 110 respectively.

The engine 100 further includes a gear train 112 that includes a crank gear 114 meshed to rotate a cam gear 116. During operation, power is transmitted from the crank gear 114 to the cam gear 116 to rotate a camshaft 118 attached to the cam gear 116. Alternatively, a belt drive or a chain drive system may be used to rotate the camshaft 118. The camshaft 118 is supported in the engine block 102 for rotation about a camshaft rotation axis AA′.

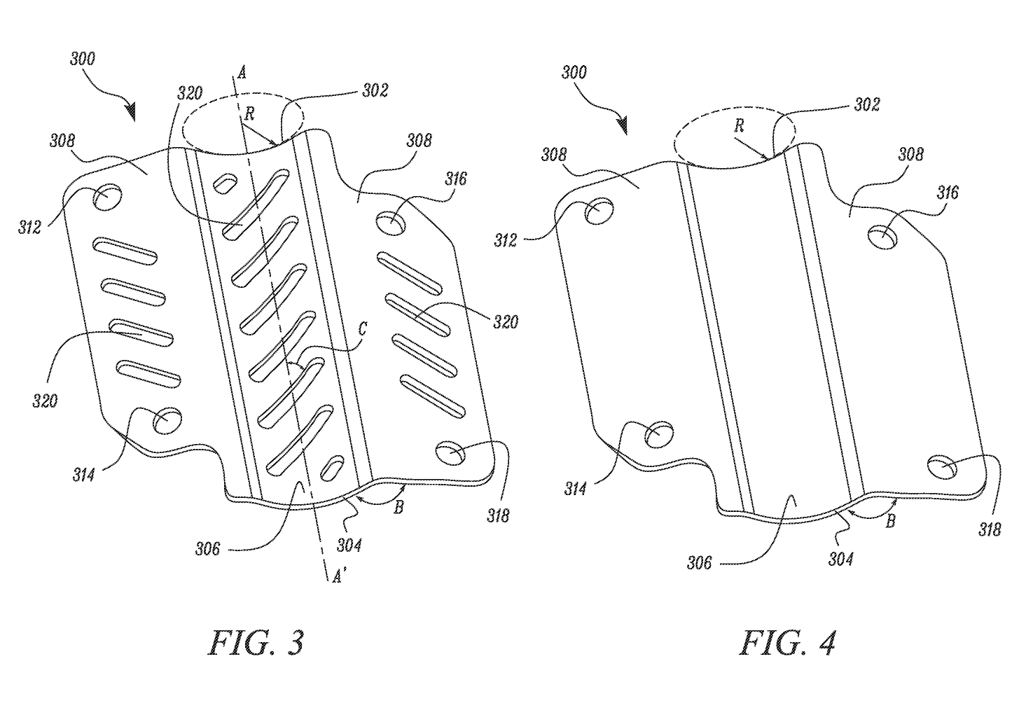

FIG. 2 illustrates a fragmentary cross-sectional view of a part of the engine block 102 shown in FIG. 1. The camshaft 118 is mounted on camshaft bearings 120 supported on transverse walls 122 extending transversely between the cylinder banks 108, 110 within the engine block 102. In an embodiment, the cylinder banks 108, 110 may also include projecting bosses 124 in which valve lifters 126 may be movably mounted. The valve lifters 126 are adapted to be operated by cams 128 provided on the camshaft 118. The camshaft 118 is supported on the camshaft bearings 120 at camshaft journals 130. The camshaft bearings 120 may include a single piece bearing and/or two halves mechanically fastened to the respective transverse wall 122 and support the camshaft 118 in place, resting on the camshaft bearings 120, during rotation.

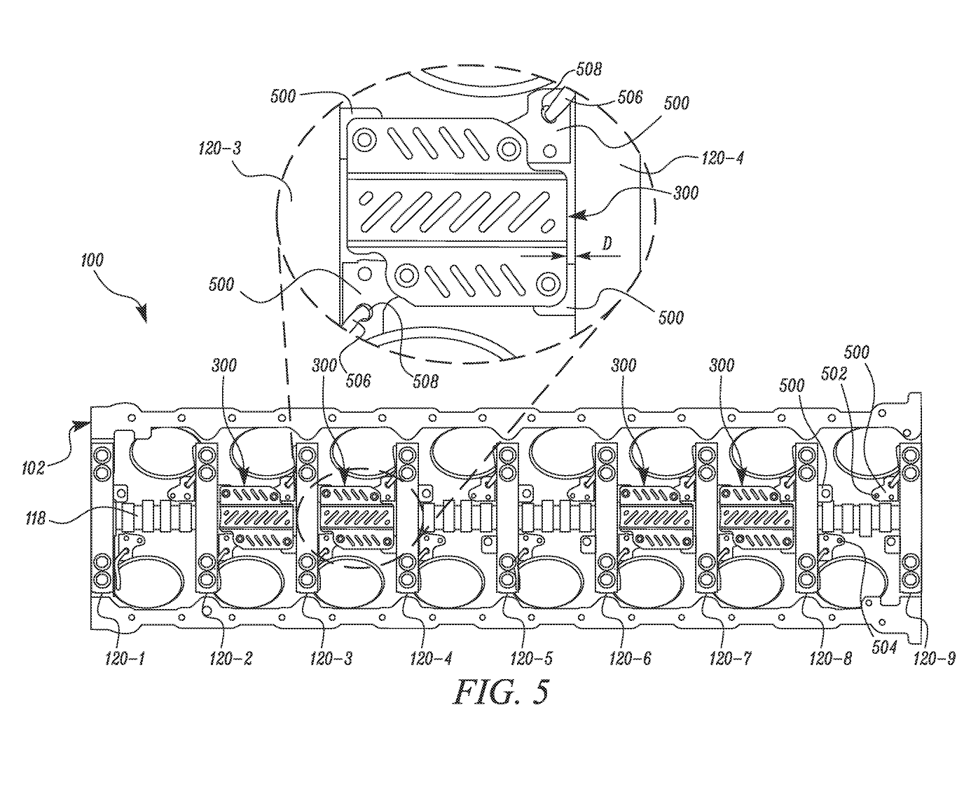

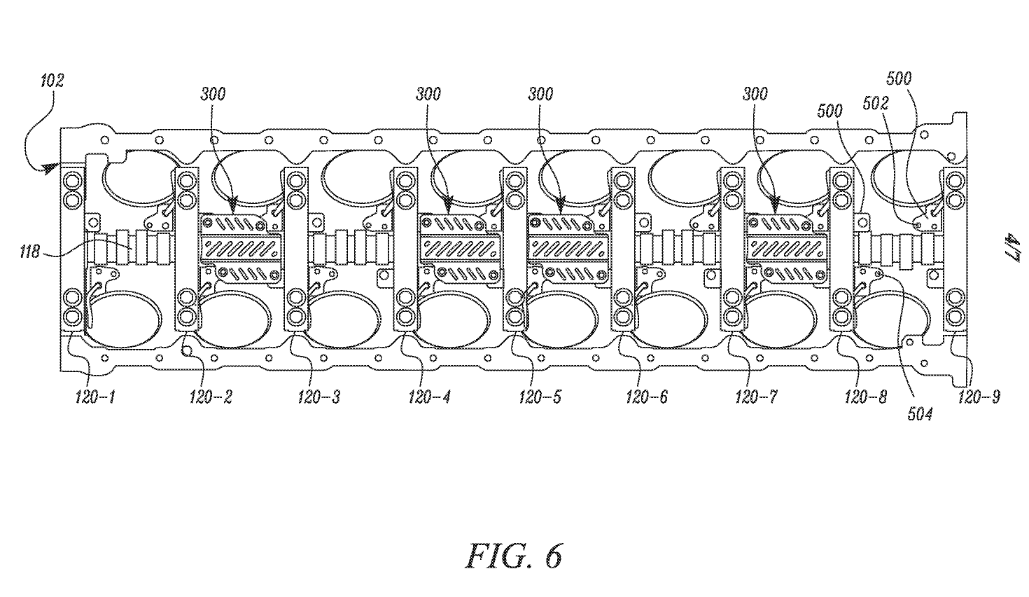

In an embodiment of the present disclosure, a camshaft guide member 300 is provided within the engine 100 for guiding the camshaft 118 through the camshaft bearings 120. In an exemplary embodiment, the camshaft guide member 300 is disposed between the camshaft bearings 120 and may be attached to the adjacent transverse walls 122. However, alternatively, the camshaft guide member 300 may be attached to any part of the engine block 102. The camshaft guide member 300 is configured to selectively support the camshaft journals 130 of the camshaft 118 during the installation and/or removal processes. The camshaft guide member 300 is described in further detail with reference to FIGS. 3 and 4.

FIGS. 3 and 4 illustrate perspective views of the camshaft guide member 300, according to two different embodiments of the present disclosure. In an exemplary embodiment, the camshaft guide member 300 may be a metallic or plastic plate to support the camshaft journals 130 during the installation and/or removal processes. In alternative embodiments, the camshaft guide member 300 may be made of other material plate capable of supporting the camshaft journals 130 while installation and/or removal of the camshaft 118 from the engine 100.

As shown in FIGS. 3 and 4, the camshaft guide member 300 may include a first end 302, a second end 304 and a contact surface 306 extending between the first end 302 and the second end 304. In an embodiment, the contact surface 306 may be a curved surface with a radius of curvature R substantially equal to a radius of the camshaft bearings 120. In alternate embodiments, the contact surface 306 may be a flat surface that is capable of supporting the camshaft journals 130. In an aspect of the present disclosure, the camshaft guide member 300 may be configured to support the camshaft 118 substantially along the camshaft rotation axis AA′ while moving the camshaft 118 for installation and/or removal purposes, as supported by the camshaft bearings 120 when the camshaft 118 is in place.

The camshaft guide member 300 may further include a connecting portion 308 configured to attach the camshaft guide member 300 to the engine 100 between a pair of camshaft bearings 120. In an exemplary embodiment, the connecting portion 308 may be a flange extending laterally from the contact surface 306. As shown in the figure, the camshaft guide member 300 may include two connecting portions 308 laterally extending from each side of the contact surface 306. Although there are two connecting portions 308 shown in the figure, it may be understood by a person having ordinary skill in the art, that the camshaft guide member 300 may include a single connecting portion 308 laterally extending from one side of the contact surface 306. In an aspect of the present disclosure, the connecting portion 308 may be disposed at a predetermined angle B with respect to the contact surface 306 of the camshaft guide member 300.

Furthermore, the connecting portion 308 of the camshaft guide member 300 may include multiple fastener receptacles 312, 314, 316, and 318 configured to receive a corresponding fastener to attach the camshaft guide member 300 to the engine 100. In an embodiment, the fastener receptacles 312, 314, 316 and 318 may be threaded receptacles to receive threaded elongated fasteners such as bolts to attach the camshaft guide member 300 to the engine 100. In another embodiment, the fastener receptacles 312, 314, 316 and 318 may be non-threaded receptacles.

In aspect of the present disclosure, the camshaft guide member 300 may include a number of slots or openings, such as openings 320 configured to reduce accumulation of debris and other contaminants on the camshaft guide member 300. In an aspect of the present disclosure, the openings 320 may be disposed at a predetermined angle “C” with respect to the camshaft rotation axis AA′. In an exemplary embodiment, the predetermined angle “C” may be substantially about 45 degrees. In an alternate embodiment, the camshaft guide member 300 may be a complete solid plate with no openings (as shown in FIG. 4). FIG. 4 illustrates a perspective view of the camshaft guide member 300 according to an alternate embodiment of the present disclosure. As will be understood by a person having ordinary skill in the art, that the camshaft guide member 300 may be a flat surfaced plate member without any curved surface and/or openings, and still support the camshaft journals 130 within the engine 100.

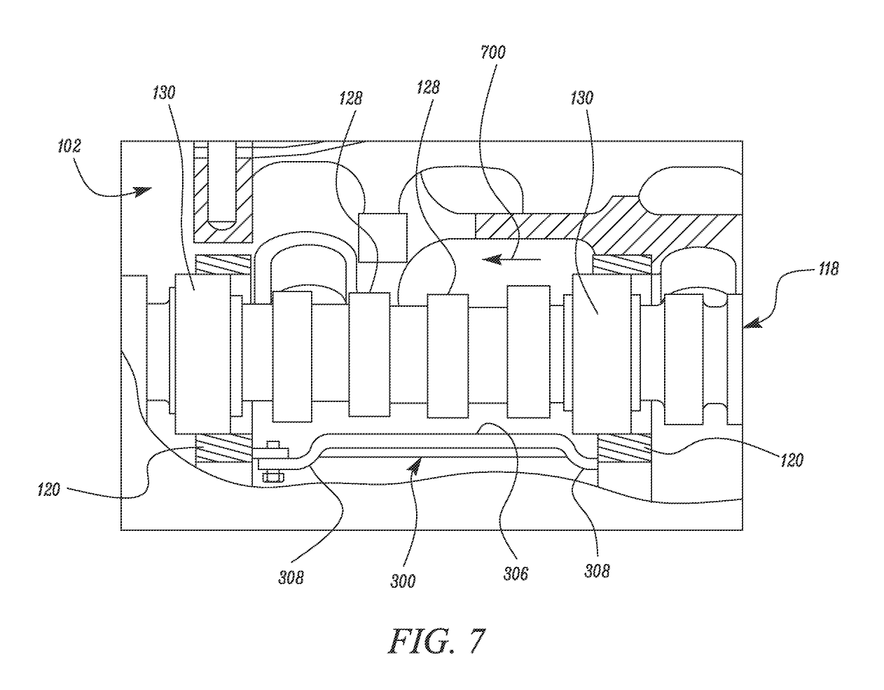

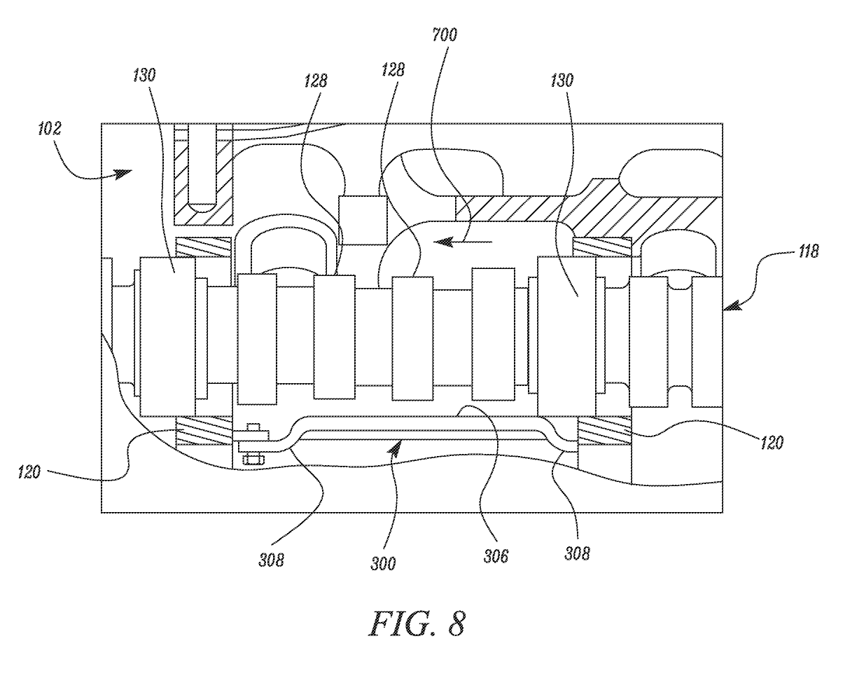

FIGS. 5 and 6 illustrate bottom views of the engine 100 having the camshaft 118 disposed within the engine 100 and the camshaft guide member 300 placed between the camshaft bearings 120, according to different embodiments of the present disclosure. As shown in FIGS. 5 and 6, there are multiple camshaft guide members 300 disposed within the engine 100.

For example, the camshaft 118 may include the camshaft bearings 120-1, 120-2, 120-3, 120-4, 120-5, 120-6, 120-7, 120-8 and 120-9. As shown in FIG. 5, the camshaft guide member 300 may be placed between the camshaft bearings (120-2, 120-3), (120-3, 120-4), (120-6, 120-7) and (120-7, 120-8). In an alternate embodiment, as shown in FIG. 6, the camshaft guide members 300 may be placed between the bearings (120-2, 120-3), (120-4, 120-5), (120-5, 120-6) and (120-7, 120-8). In an embodiment of the present disclosure, the camshaft guide member 300 may be attached to the engine 100 between the pair of camshaft bearings 120 at a predetermined distance “D” from the camshaft bearings 120. For example, the predetermined distance “D” is less than a thickness of the camshaft journal 130. The thickness of the camshaft journal 130 may be defined as an axial width of the camshaft journal 130 along the camshaft rotation axis AA′.

In an aspect of the present disclosure, each of the camshaft guide members 300 is attached to the engine 100 via an attachment plate 500 as shown in FIGS. 5 and 6. For example, the attachment plate 500 may be attached or integrally formed within the engine 100 at the transverse wall 122. In an alternate embodiment, the attachment plate 500 may be a separate plate that may be placed within the engine 100 to fasten the camshaft guide member 300 to the engine 100. The attachment plate 500 may include a number of fastener receptacles, such as second fastener receptacles 502 and 504 configured to be aligned with the corresponding first fastener receptacles 312, 314, 316 and 318 provided on the connecting portion 308 of the camshaft guide member 300.

In an aspect of the present disclosure, the attachment plate 500 may be configured to receive a piston cooling jet tube 506 of the engine 100. For example, the attachment plate 500 may include an additional receptacle, such as receptacle 508 to receive the piston cooling jet tube 506. As will be understood by a person having ordinary skill in the art, that a piston cooling jet tube 506 may be used to cool underside of the pistons 106 that are heated during operations. The piston cooling jet tube 506 sprays oil into cooling channels on the underside of pistons 106, cooling the piston crowns by absorbing heat, thus lowering piston temperatures. In an alternate embodiment, the piston cooling jet tube 506 may be attached directly to the camshaft support member 300, thereby omitting the attachment plate 500. For example, the camshaft support member 300 may include an additional receptacle (not shown) to receive the piston cooling jet tube 320.

Further, the second fastener receptacles 502 and 504 of the attachment plate 500 and the fastener receptacles 312, 314, 316 and 318 of the connecting portion 308 of the camshaft guide member 300 may be aligned and fastened together to attach the camshaft guide member 300 to the engine 100. For example, a fastener 508 such as a bolt is received within the first and the second fastener receptacles. In an embodiment, the camshaft guide member 300 may be bolted to the engine 100. In alternative embodiments, the camshaft guide member 300 may be welded or riveted to the engine 100 via the attachment plate 502.

### INDUSTRIAL APPLICABILITY

The industrial applicability of the camshaft guide member 300 for installing and removing the camshaft 118 from the engine 100 described herein will be readily appreciated from the foregoing discussion. The camshaft guide member 300 facilitates easy and convenient installation and removal of the camshaft 118 without damaging the camshaft bearings 120 and profile of the cams 128. The camshaft guide member 300 is positioned at the predetermined distance “D” les than the thickness of the camshaft journals 130 to prevent falling of the cams 128 onto the camshaft bearing 120. The openings 320 are disposed at the predetermined angle “C” with respect to the camshaft rotation axis AA′, so as to prevent interference of the openings 320 with the camshaft 118. Furthermore, the design of camshaft guide member 300 provides easy and simple manufacturing. The camshaft guide member 300 may be provided within the engine 100 at the time of assembling the engine 100.

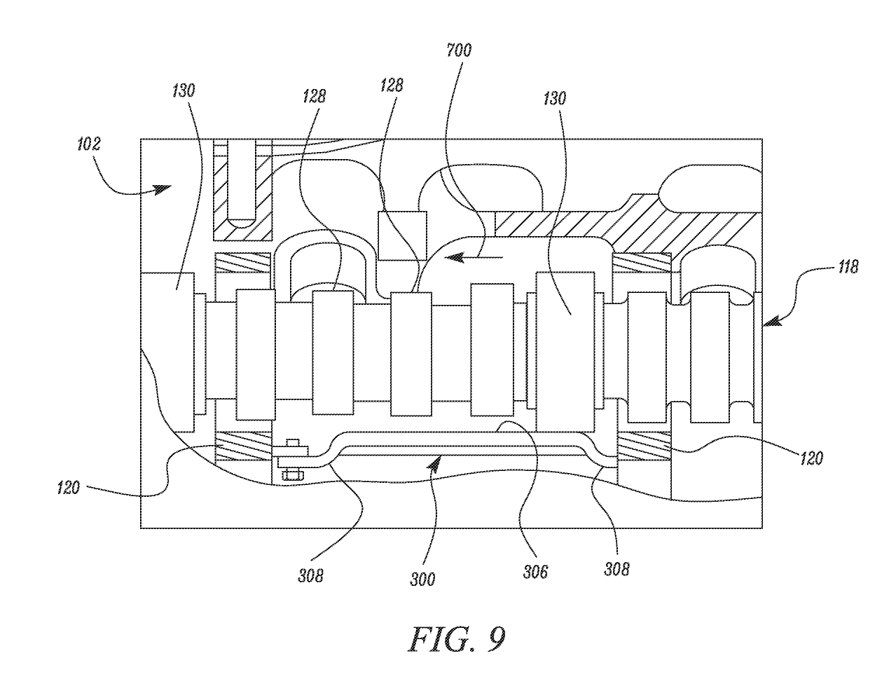

FIGS. 7, 8 and 9 illustrate diagrammatic views of guiding the camshaft 118 through the camshaft bearings 120. In an aspect of the present disclosure, the camshaft guide member 300 is provided between the camshaft bearings 120 within the engine 100. Further, the camshaft 118 is moved while supporting the camshaft journals 130 on the camshaft guide member 300.

In an exemplary embodiment, a removal process is shown in FIGS. 7 to 9. When in place, the camshaft journals 130 are supported on the corresponding camshaft bearings 120. Initially, while moving the camshaft 118, the camshaft journal 130 is supported on the camshaft bearing 120, as shown in FIG. 7. Further, as the camshaft 118 moves in the direction shown by arrow 700, the camshaft journal 130 is partially supported on the camshaft guide member 300 before disengaging from the camshaft bearing 120, as shown in FIG. 8. As the predetermined distance “D” of the camshaft guide member 300 from the camshaft bearings 120 is less than the thickness of the camshaft journal 130, the camshaft journal 130 is prevented from falling and is supported on the camshaft guide member 300. Furthermore, the camshaft journal 130 is completely supported on the camshaft guide member 300 (as shown in FIG. 9) as it is guided through the camshaft bearings 120 for removal of the camshaft 118 from the engine 100 for servicing purposes.

Similarly, for installing the camshaft 118 within the engine 100, the camshaft journal is initially supported on the camshaft bearing 120, and further partially supported on the camshaft guide member 300 before disengaging from the camshaft bearing 120.

Therefore, the camshaft 118 is safely removed or installed within the engine 100, without any need to open the engine 100 and also without any damage to the camshaft bearing 120 within the engine 100.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A camshaft guide member for guiding a camshaft through a plurality of axially aligned camshaft bearings in an engine along a camshaft rotation axis, the camshaft guide member comprising:
a first end;
a second end;
a contact surface extending between the first end and the second end; and
a connecting portion configured to attach the contact surface to the engine between at least a pair of camshaft bearings.

2. The camshaft guide member of claim 1, wherein the contact surface has a radius of curvature substantially equal to a radius of the camshaft bearing.

3. The camshaft guide member of claim 1, wherein the contact surface has at least one opening.

4. The camshaft guide member of claim 3, wherein the at least one opening is disposed at substantially about 45 degrees with respect to the camshaft rotation axis.

5. The camshaft guide member of claim 1, wherein the connecting portion is a flange laterally extending from the contact surface.

6. The camshaft guide member of claim 1, wherein the connecting portion includes at least one fastener receptacle configured to receive a fastener to attach the camshaft guide member within the engine.

7. An engine comprising:
a plurality of axially aligned camshaft bearings;
a camshaft rotatably supported on at least two axially aligned camshaft bearings and configured to rotate about a camshaft rotation axis; and
a camshaft guide member configured to guide the camshaft through the camshaft bearings, the camshaft guide member including:
a first end;
a second end; and
a contact surface extending between the first end and the second end and disposed between the at least two camshaft bearings.

8. The engine of claim 7, wherein the camshaft guide member further includes a connecting portion laterally extending from the contact surface and including a first fastener receptacle, the connecting portion attaching the camshaft guide member to the engine between the at least two camshaft bearings.

9. The engine of claim 8, wherein the camshaft bearings are supported on transverse walls extending within the engine, and wherein the connecting portion is attached to the transverse wall.

10. The engine of claim 9 further including an attachment plate having a second fastener receptacle, wherein the attachment plate is attached to the transverse wall.

11. The engine of claim 8, wherein the first fastener receptacle is aligned with a second fastener receptacle provided on an attachment plate, a fastener is received within the first and the second fastener receptacles.

12. The engine of claim 10, wherein the attachment plate supports a piston cooling jet within the engine.

13. The engine of claim 7, wherein the contact surface is disposed at a pre-determined distance from the camshaft bearings, and wherein the pre-determined distance is less than a thickness of the camshaft journal.

14. The engine of claim 7, wherein the contact surface has a radius of curvature substantially equal to a radius of the camshaft bearing.

15. The engine of claim 7, wherein the contact surface has at least one opening.

16. The engine of claim 15, wherein the at least one opening is disposed at substantially about 45 degrees with respect to the camshaft rotation axis.

17. A method of guiding a camshaft through a plurality of axially aligned camshaft bearings in an engine, the method comprising:
providing at least one camshaft guide member between at least two camshaft bearings; and
moving the camshaft while continuously supporting a camshaft journal on at least one of the camshaft guide member and the camshaft bearing.

18. The method of claim 17, wherein moving the camshaft comprises at least one of installing and removing the camshaft.

19. The method of claim 18, wherein installing the camshaft comprises partially supporting the camshaft journal by the camshaft bearing before disengaging the camshaft journal from the camshaft guide member.

20. The method of claim 18, wherein removing the camshaft comprises partially supporting the camshaft journal by the camshaft guide member before disengaging the camshaft journal from the camshaft bearing.
